(19) United States
(12) Patent Application Publication
(10) Pub. No.: US 2011/0243813 A1
(43) Pub. Date: Oct. 6, 2011

(54) DIAGNOSTIC CARD WITH MICRO-FLUIDIC CHANNELS AND METHOD OF CONSTRUCTION THEREOF

(76) Inventors: Steve W. Jackinsky, Denver, CO (US); Peter W. Kroehi, Denver, CO (US); David W. Wright, Littleton, CO (US)

(21) Appl. No.: 13/075,515

(22) Filed: Mar. 30, 2011

Related U.S. Application Data
(60) Provisional application No. 61/318,984, filed on Mar. 30, 2010.

(51) Int. Cl. B01L 3/00; B29C 65/16

(52) U.S. Cl. 422/503; 156/272.8; 156/213

(57) ABSTRACT

An in vitro diagnostic card and method of construction thereof is provided. The card includes an intermediate layer having opposite faces with at least one channel extending through the faces. A translucent first layer is fixed to one of the faces of the intermediate layer and a translucent second layer is fixed to the other of the faces of the intermediate layer opposite the translucent first layer. The channel in the intermediate layer is substantially sealed off by the first and second layers. Further, an opaque material that is absorbent to laser beam energy bonds the intermediate layer to the first and second layers.

### CROSS-REFERENCE TO RELATED APPLICATION

This application claims the benefit of U.S. Provisional Application Ser. No. 61/318,984, filed Mar. 30, 2010, which is incorporated herein by reference in its entirety.

### BACKGROUND OF THE INVENTION

1. Technical Field

This invention relates generally to diagnostic cards having micro-fluidic channels and to their methods of construction.

2. Related Art

Typically, micro fluidic cards, or fluid networks are comprised of a three dimensional shape, molded in plastic and assembled using pressure sensitive adhesives or some other standard intermediate bonding agent. The geometry is created in a computer aided design (CAD) system, or other design tool, at which point an injection molding tool is produced reflecting the geometry. The tool is placed in an injection molding press, and plastic is injected into the cavity, representing the desired shape, thus producing a component of the final assembly. The entire process of designing, tooling and eventually molding a component takes approximately two months. The components are assembled in layers, typically using pressure sensitive adhesives (PSA's), or some other standard bonding agent. PSA's rely on the principals of surface energy. Standard adhesive formulations wet out and bond high surface energy (HSE) surfaces such as ABS plastic, but fail to bond low surface energy (LSE) polyolefins that include polypropylene and polyethylene.

PSA's are common in the manufacture of micro fluidic cards, however, they present several problems to the manufacture of and performance of the end product. PSA's degrade over time and thus, they have a limited shelf life. Also, because PSA's are a visco-elastic chemical, they let off gas, commonly referred to as “off-gas” over time. The gas released from the PSA migrates through the assembly and binds to the exposed surfaces of the layered walls. Thus, the exposed sides of the walls that bound fluid flow channels within the cards become contaminated by the off-gas. Accordingly, in the case of a micro-fluidic diagnostic device, where biologic and chemical fluids are present, the presence of this foreign off-gas substance may impede or inhibit fluid transfer through the card. In some cases, the presence of this foreign substance may attract and bind key chemicals, antibodies, or cellular matter of importance. Additionally, PSA's contribute a dimensional attribute to the assembly because of their inherently variable thickness. Unfortunately, the variable thicknesses alter the desired dimensions of the micro-fluidic channels, thus, affecting the desired capillary action of the fluidic system.

### SUMMARY OF THE INVENTION

An in vitro diagnostic card constructed in accordance with one aspect of the invention includes an intermediate layer having opposite faces with at least one channel extending through the faces. A translucent first layer is fixed to one of the faces of the intermediate layer and a translucent second layer is fixed to the other of the faces of the intermediate layer opposite the translucent first layer. The channel in the intermediate layer is substantially sealed off by the first and second layers. Further, an opaque material that is absorbent to laser beam energy bonds the intermediate layer to the first and second layers.

In accordance with another aspect of the invention, a method of constructing an in vitro diagnostic card is provided. The method includes providing an intermediate layer having opposite faces with one or more channels extending through the faces. Further, placing a translucent first layer against one of the faces of the intermediate layer and placing a translucent second layer against the other of the faces of the intermediate layer opposite the first layer. Then, bonding the first and second layers to the intermediate layer with a laser beam.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is an exploded perspective view of a diagnostic card in accordance with one presently preferred embodiment of the invention;

FIG. 2 is an assembled perspective view of the diagnostic card of FIG. 1;

FIG. 2A is a cross-sectional view taken generally along the line 2A-2A of FIG. 1;

FIG. 2B is a cross-sectional view similar to FIG. 2A of a diagnostic card constructed in accordance with another embodiment of the invention;

FIG. 3 is an exploded perspective view of a diagnostic card in accordance with another presently preferred embodiment of the invention;

FIG. 3A is a cross-sectional view similar to FIG. 2A taken through the diagnostic card of FIG. 3; and

FIG. 4 is a schematic representation of a method of constructing the diagnostic cards of FIGS. 1 and 3.

### DETAILED DESCRIPTION OF PRESENTLY PREFERRED EMBODIMENTS

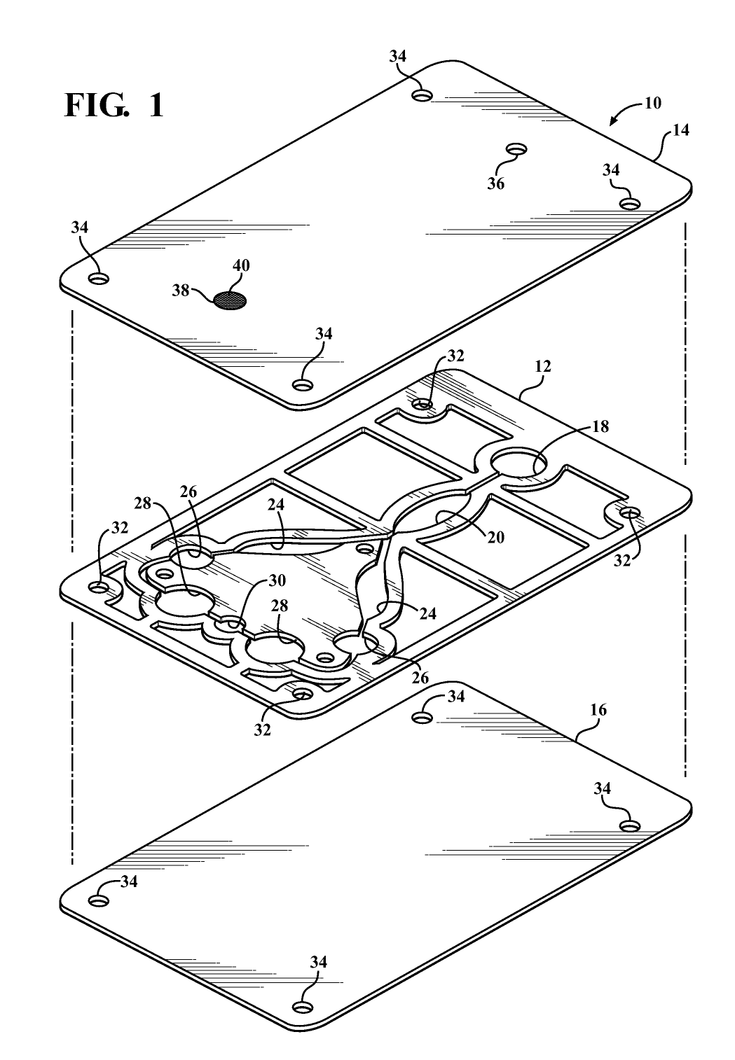

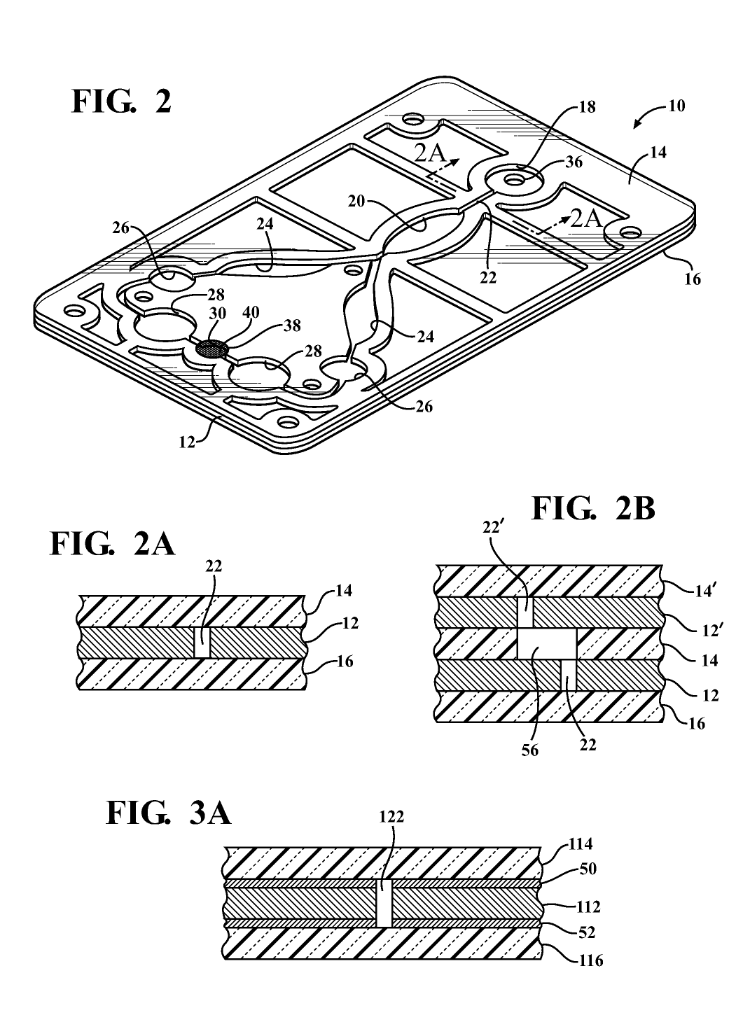

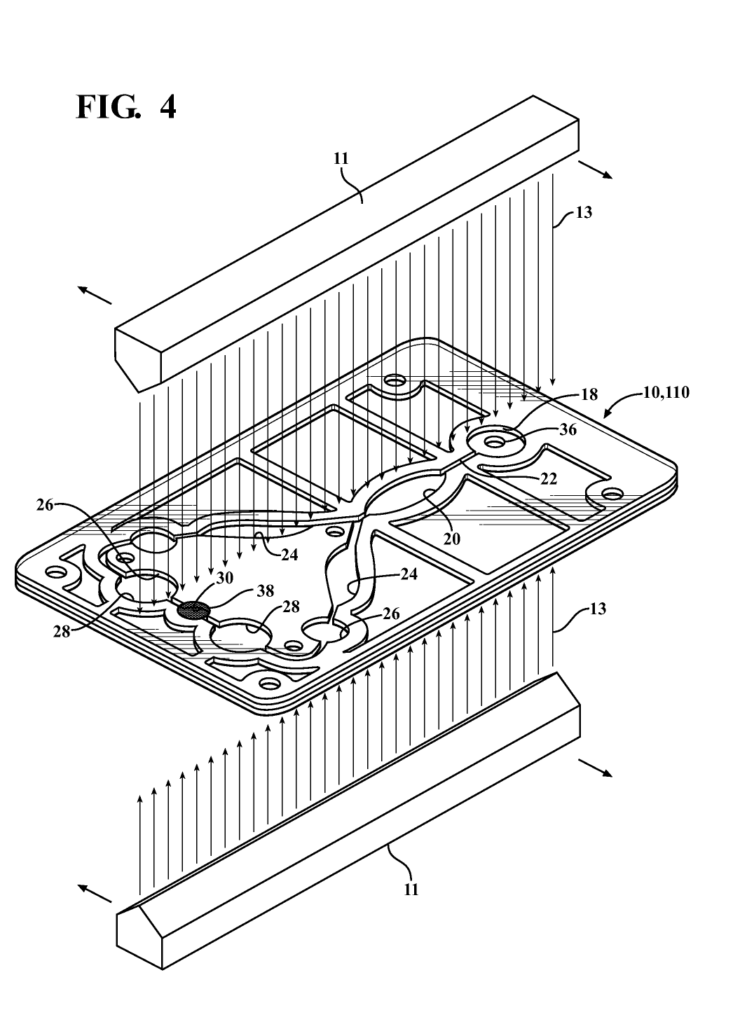

Referring in more detail to the drawings, FIGS. 1 and 2 illustrate an in vitro diagnostic card 10 constructed in accordance with one presently preferred embodiment of the invention. The process used to construct the card 10 (FIG. 4) makes use of at least one layer of material that is visible in the spectrum of a laser welder 11, shown here, by way of example and without limitation, as an intermediate micro-fluidic channel forming layer 12. The channel forming layer 12 may be constructed by one of many methods, including but not limited to: laser cutting, rule-die cutting, water jet cutting, punch-die forming and injection molding. The channel forming layer 12 is opaque, and thus, absorbs a suitable amount of energy from a laser welding spectrum, also referred to as laser beam 13, to form a bond between the intermediate layer 12 at least one, and shown here as a pair of outer first and second layers, also referred to as top and bottom layers 14, 16. The opaque, intermediate card 12 provides the configuration of material necessary to provide structure and form to the card 10, while having material unnecessary to the function or form of the card 10 removed therefrom so as to minimize the laser welding cycle time and to assure welding only results in the desired regions between the intermediate layer 12 and the outer layers 14, 16.

The top and bottom layers 14, 16 are constructed of a material that is translucent or substantially translucent to the laser beam 13 and thus, the layers 14, 16 do not absorb a substantial amount of energy, if any, from the laser beam 13 during assembly.

The intermediate layer 12 has opposite faces with one or more micro-fluidic channels extending through the faces. The micro-fluidic channel is represented here as through channel, including a sample entry chamber 18; a sample volume retention chamber 20; a capillary channel (wicking channel) 22 interconnecting the sample entry chamber 18 to the sample volume retention chamber 20; at least one and shown as a pair of reagent mixing chambers 24; sample filtering and venting chambers 26 extending from the reagent mixing chambers 24; detection chambers 28; and a down-stream air venting port 30 interconnected with the detection chambers 26. Further, the intermediate layer 12 has a plurality of location features, shown as openings 32. The opaque layer 12 may also include one or more floating members. Floating members are those that are not contiguous or connected with the material of the layer 12.

The transparent top and bottom layers 14, 16 have a plurality of location features, shown as openings 34. The openings 34 are configured to register with the openings 32 in the intermediate layer 12 to facilitate assembly. Further, at least one of the layers 14, 16, shown as the top layer 14 has a sample introduction window, represented as an opening 36 configured to align with the sample entry chamber 18 upon assembly. Further, at least one of the layers 14, 16, shown as the top layer 14 has a vent passage 38 with a hydrophobic vent material 40 extending thereover. Accordingly, gas is free to vent through the vent material 40, while fluid is prevented from passing therethrough.

The process of constructing the card 10 includes forming the opaque layer 12 having the desired features described above, i.e. channel, including chambers and capillary channels, and the top and bottom layers 14, 16 having the desired features described above, i.e. location openings, sample introduction opening, vent passage, such as in a laser cutting, rule-die cutting or other suitable cutting/forming method. Then, the process includes “sandwiching” the opaque layer 12 between the opposite top and bottom transparent or translucent layers 14, 16 and aligning the layers 12, 14, 16 in their proper relative orientation via the location features 32, 34. Further, disposing the “sandwiched” layers 12, 14, 16 in a welding nest. During assembly, the intermediate layer 12 and top layer 14 can be configured in their desired orientation relative to one another and placed in a mold nest with the optically opaque component 12 furthest away from the laser 11. As such, laser treatment, the laser beam 13 passes through the top layer 14 (optically clear component) and impinges the intermediate opaque layer 12 at the interface of the mating layers 12, 14. As such, the region of the intermediate layer 12 impinged by the laser beam 13 is caused to melt via the absorbed laser energy, thereby causing the intermediate layer 12 and the top layer 14 to be laser welded in permanently bonded relation with one another upon cooling without the use of a separate adhesive material. The partial assembly of the bonded intermediate layer 12 and top layer 14 is removed from the weld nest, flipped over, and the process is repeated by placing and aligning the bottom layer 16 on the intermediate layer 12, thus bonding the opaque intermediate layer 12 to the translucent bottom layer 16, thereby producing a sealed finished product 10. Accordingly, the top and bottom layers 14, 16 seal off the channel of the intermediate layer 12. Of course, rather than removing and flipping the bonded pairs of layers 12, 14, the laser beam emitting device 11 can be rotated about the layers and/or an additional laser beam emitting device 11 can be employed to laser weld both sides of the “sandwiched” layers 12, 14, 16 simultaneously without the use of a separate adhesive material, as shown in FIG. 4.

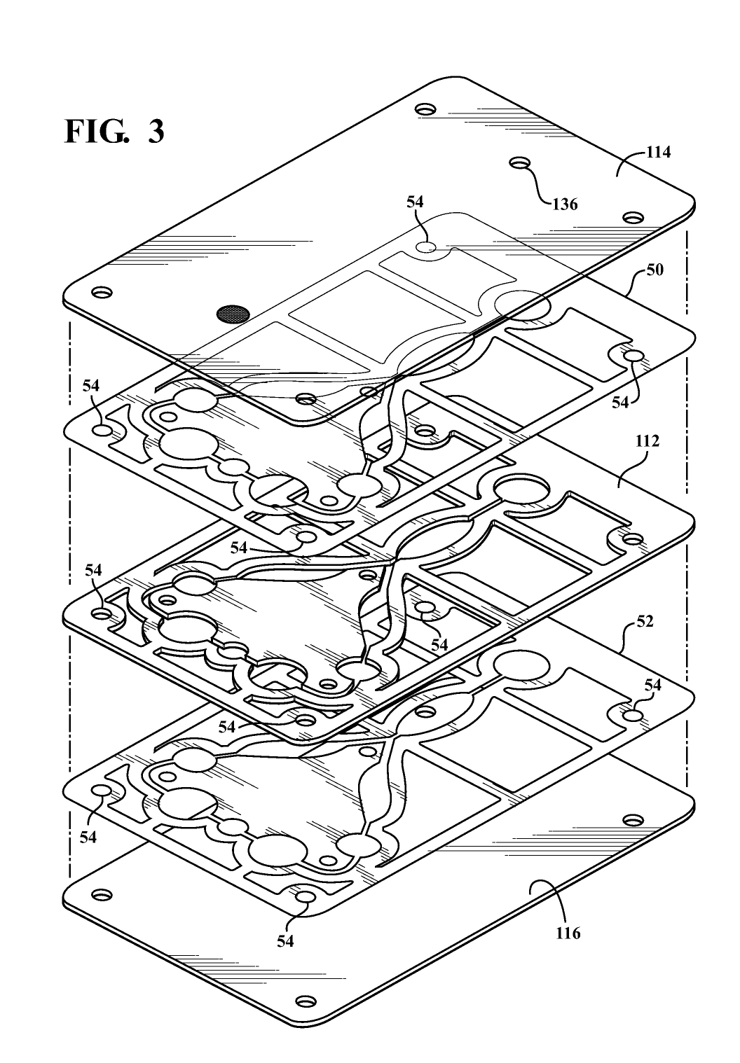

In FIG. 3, an exploded view of an in vitro diagnostic card 110 constructed in accordance with another aspect of the invention is shown, wherein similar features as discussed above are identified by the same reference numerals, offset by a factor of 100. The notable difference with the card 110 is that rather than the intermediate layer 112 being constructed of an opaque, laser absorbing material, a pair of additional opacified hot-melt layers 50, 52 are sandwiched between the intermediate layer 112 and the top and bottom layers 114, 116. Accordingly, the intermediate layer 112 and the top and bottom layers 114, 116 can be constructed of transparent or substantially transparent material to allow the laser beam 13 to be transmitted therethrough, while the layers 50, 52 absorb the energy of the laser beam 11. Accordingly, the impinged regions of the layers 50, 52 are caused to melt, thereby causing the intermediate layer 112 and the respective top and bottom layers 114, 116 to be bonded together to form the assembly 110 without the use of a separate adhesive material.

The opacified layers 50, 52 can be formed from a hot-melt material that is opacified such that the hot-melt material becomes laser absorbing. Then, the opacified hot-melt material can be cut to take on the desired skeleton configuration, such as in a die-cut process, for example. The layers 50, 52 are preferably formed having the same functional configuration as the intermediate layer 112 along with location openings 54, thereby allowing the layers 112, 114, 116, 50, 52 to be properly aligned with one another prior to initiating the laser bonding process. As with the previous embodiment, upon aligning the respective layers with one another, the laser 11 is passed over the top and bottom layers 114, 116, whereupon the impinged regions of the hot-melt layers 50, 52 are caused to melt. Thus, the intermediate layer 112 is bonded to the top and bottom layers 114, 116 via the intermediate, opacified hot-melt layers 50, 52.

In addition, it should be recognized that the number of intermediate layers 12, 112 and translucent layers 14, 16, 114, 116 can be other than shown. For example, as shown in FIG. 2B, one or more additional intermediate layers, shown as one additional intermediate layer 12′, by way of example and without limitation, can be overlaid on either or both of the respective first and second translucent layers, shown as the first translucent layer 14, with an additional third translucent layer 14′ being overlaid on the intermediate layer 12′, thereby producing a 3-D card construction having multiple opaque channel layers staggered along parallel planes relative to one another with a translucent layer being sandwiched therebetween. Further, the channels 22, 22′ in the stacked intermediate layers 12, 12′ can be brought into fluid communication with one another via a passage, shown as a slightly enlarged, offset passage 56, extending through the corresponding intermediate translucent layer 14, as desired, or they can be maintained completely out of fluid communication from one another, if desired. It should be recognized that as with the previous embodiments, the intermediate layers 12, 12′ can themselves be made opaque to absorb welding energy from the laser beam 13, or an opacified hot melt layer can be disposed between the intermediate layers 12, 12′ to facilitate bonding the individual layers to one another via the laser beam 13.

Obviously, many modifications and variations of the present invention are possible in light of the above teachings. It is, therefore, to be understood that within the scope of the appended claims, the invention may be practiced otherwise than as specifically described.

What is claimed is:

1. An in vitro diagnostic card, comprising:
at least one intermediate layer having opposite faces with at least one channel extending through said faces;
a translucent first layer fixed to one of said faces of said intermediate layer;
a translucent second layer fixed to the other of said faces of said intermediate layer opposite said translucent first layer, said channel being substantially sealed off by said first and second layers; and
an opaque material that is absorbent to laser beam energy bonding said intermediate layer to said first and second layers.

2. The in vitro diagnostic card of claim 1 wherein said intermediate layer is constructed as said opaque material.

3. The in vitro diagnostic card of claim 1 wherein said intermediate layer is translucent.

4. The in vitro diagnostic card of claim 3 wherein said opaque material is provide as separate layers of material positioned between said intermediate layer and said first and second layers.

5. The in vitro diagnostic card of claim 4 wherein said opaque material is a hot-melt material.

6. The in vitro diagnostic card of claim 5 wherein said opaque material is configured having substantially the same shape as said intermediate layer.

7. The in vitro diagnostic card of claim 1 wherein said first and second layers are laser welded to said intermediate layer.

8. The in vitro diagnostic card of claim 1 wherein said first and second layers are bonded to said intermediate without a separate adhesive.

9. The in vitro diagnostic card of claim 1 wherein said channel includes a sample entry chamber and sample retention chamber interconnected with one another by a capillary channel, said first and second layers sealing off said sample entry chamber, said sample retention chamber and said capillary channel.

10. The in vitro diagnostic card of claim 1 wherein at least one of the first or second translucent layers has a hydrophobic vent.

11. The in vitro diagnostic card of claim 1 wherein said intermediate layer and said first and second layers have location features configured to orient said intermediate layer and said first and second layers relative to one another.

12. The in vitro diagnostic card of claim 1 further including a pair of intermediate layers extending generally parallel to one another with one of said first or second translucent layers sandwiched between said pair of intermediate layers.

13. The in vitro diagnostic card of claim 12 wherein said translucent layer sandwiched between said pair of intermediate layers has a passage and said pair of intermediate layers are in fluid communication with one another through said passage.

14. A method of constructing an in vitro diagnostic card, comprising:
providing an intermediate layer having opposite faces with one or more channels extending through the faces;
placing a translucent first layer against one of the faces of the intermediate layer;
placing a translucent second layer against the other of the faces of the intermediate layer opposite the first layer; and
bonding the first and second layers to the intermediate layer with a laser beam.

15. The method of claim 14 further including providing the intermediate layer as an opaque material that is absorbent to energy of the laser beam.

16. The method of claim 14 further including providing the intermediate layer as a translucent material.

17. The method of claim 16 further including positioning separate opaque layers that are absorbent to energy of the laser beam between the intermediate layer and the first and second layers and bonding the intermediate layer to the first and second layers by melting the opaque layers with the laser beam.

18. The method of claim 17 further including providing the opaque layers as an opacified hot-melt material.

19. The method of claim 17 further including configuring the opaque layers having substantially the same shape as the intermediate layer.
